(19) United States
(12) Patent Application Publication
(10) Pub. No.: US 2026/0199796 A1
(43) Pub. Date: Jul. 16, 2026

(54) System for Conducting a Long Drive Tournament

(71) Applicant: Robert Oates Peterson, Newton Grove, NC (US)

(72) Inventor: Robert Oates Peterson, Newton Grove, NC (US)

(21) Appl. No.: 19/559,898

(22) Filed: Mar. 6, 2026

Related U.S. Application Data
(62) Division of application No. 18/482,902, filed on Oct. 8, 2023.
(60) Provisional application No. 63/414,723, filed on Oct. 10, 2022.

(51) Int. Cl. A63F 13/812; A63F 13/573; A63F 13/798

(52) U.S. Cl. CPC A63F 13/812; A63F 13/573; A63F 13/798

(57) ABSTRACT

Embodiments of a system to conduct and stage a long drive tournament at one or more physical and/or virtual long drive grids, using competition divisions based upon a novel handicap system and method for the sport of long driving that rates long drivers from novice participants to professional long drivers, which competition divisions group tournament competitors participating in a long drive tournament not by age or gender but rather by speed ability thus enabling the sport of long driving to become a neutral sport accessible to all humans are generally described in this disclosure. Other embodiments may be described and claimed.

### CROSS-REFERENCE TO RELATED APPLICATIONS

This application is a United States non-provisional application and claims priority to U.S. provisional patent application No. 63/414,723, filed Oct. 10, 2022, the entire contents of which are incorporated herein by reference.

### STATEMENT REGARDING FEDERALLY SPONSORED RESEARCH OR DEVELOPMENT

The research for the patent “Method and System For Conducting A Long Drive Tournament” was not funded by any federally sponsored research or development.

### THE NAMES OF THE PARTIES TO A JOINT RESEARCH AGREEMENT

Not applicable.

### INCORPORATION-BY-REFERENCE OF MATERIAL SUBMITTED ON A READ-ONLY OPTICAL DISC, AS A TEXT FILE OR AN XML FILE VIA THE PATENT ELECTRONIC SYSTEM

Not applicable.

### STATEMENT REGARDING PRIOR DISCLOSURES BY THE INVENTOR OR A JOINT INVENTOR

Not applicable.

### TECHNICAL FIELD OF THE INVENTION

The invention relates generally to the sport of long driving, and, more particularly, to methods and systems for conducting and scheduling long driving tournaments (each, a “long drive tournament”) using physical and/or virtual long drive grids and a novel handicap system and method in the sport of long driving that rates practitioners of the sport of long driving (each, a “long driver”; collectively, “long drivers”) from novice participants to professional long drivers, including: creating new competition divisions for a long drive tournament based on this long drive handicap system and method, which divisions are designed to make long driving a neutral sport accessible to all long drivers, irrespective of age or gender; and the development of novel scoring methods and systems for such long drive tournaments.

### BRIEF SUMMARY OF THE INVENTION

It is an objective of the present invention to provide a novel handicap method and system for the sport of long driving using a computing system that rates or otherwise ranks long drivers in the sport of long driving not according to age or gender, but rather according to ability.

It is a further object of the present invention to, using this long drive handicap method and system, provide a method and system for conducting a long drive tournament that: (1) provides means for the use of physical and/or virtual long drive grids for long drive competitions enabling tournament competitors to participate in, and audiences to watch, long drive competitions globally; (2) creates new competition divisions (each, a “speed division”) based upon the long drive handicap method and system making the long drive tournament more competitive at all tournament levels; (3) through the speed divisions, ensures that there is a more level-playing field among, and allows greater interaction between, the long drivers participating in a long drive tournament (each, a “tournament competitor”); (4) organizes the long drive tournament competition rounds in each speed division in a manner that is more likely to match the most-skilled tournament competitors in the final tournament stage or stages, regardless of first round match-ups; (5) provides means for livestreaming and organizing the long drive tournaments in a manner that is more fast-paced and entertaining; and (6) through the creation of the novel speed divisions, enables the sport of long driving to become a neutral sport accessible to all humans—where long drivers can compete against one another in long drive tournaments irrespective of age or gender.

These and other features of the invention will be more fully described in the following detailed description. Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

Embodiments of the invention are illustrated in the figures of the accompanying drawings by way of general example, and under no circumstances by way of limitation. Other embodiments may be described and claimed.

FIG. 1 is a schematic diagram depicting a long drive competition area, including the long drive grid; the tee-boxes from where the long drivers attempt to hit onto the long drive grid; and an out-of-bounds area, in accordance with a preferred embodiment of the present invention.

FIG. 2 is a diagram representing the ball speed, clubhead speed, and efficiency ratio ratings of the example long drive handicap system.

FIG. 3 is a flow diagram depicting an approach for calculating the long driver handicap for long drivers according to an embodiment.

FIG. 4 is a block diagram of a computing system or other central processing unit upon which embodiments of the invention may be implemented.

FIG. 5 is a block diagram depicting a system for collecting the rating information and long drive handicap information for multiple individuals; and ranking the long drive handicaps of the individuals based on the most up-to-date long drive handicap and rating information for each individual for whom the information has been collected.

FIG. 6 is a table depicting how different Speed Divisions could be created for a long drive tournament, where each tournament competitor would be grouped into different Speed Divisions based upon the long drive handicap described in the present invention of each tournament competitor.

FIG. 7 is a flow diagram depicting an approach for conducting the various rounds of a Speed Division within a long drive tournament according to an embodiment.

FIG. 8 is a table depicting how, using the present invention's derivative form of “pool system” groupings for a long drive tournament, the tournament competitors in one pool of a Speed Division of a long drive tournament could be paired with the other tournament competitors in that same pool to play matches against each other during a round to ensure that each tournament competitor in that pool within the Speed Division plays against each other tournament competitor in that pool at least once during the round.

### DETAILED DESCRIPTION OF THE INVENTION

The present invention relates to a system and method for conducting a long drive tournament based upon a novel long drive handicap system using a computing device, that ranks long drivers and is designed to make long driving a neutral sport accessible to all humans—where long drivers can compete against one another in long drive tournaments and other competitions irrespective of age or gender.

In the following description, for purposes of explanation, specific details are set forth in order to provide an understanding of the present invention. It will be apparent that the invention may be practiced without those specific details.

This invention is being described referring to the embodiments illustrated in the drawings, however, such descriptions, are only exemplary and explanatory, and it is obvious that anyone who has common knowledge in the field of art of this invention will be able to edify, change, or add in a wide variety not departing from the spirit and the scope of this invention.

### 1. Background

The sport known as “traditional golf” is typically played on a 9- or 18-hole golf course, where each hole on the course is given its own par rating (i.e., the number of strokes to complete a hole). For each hole on the golf course, the player of the sport of golf (referred to as a “golfer”) uses different golf clubs for a variety of different strokes (i.e., drive stroke, chip stroke, putt stroke) to progressively hit a golf ball all the way from the teeing box at the beginning of the hole until the golf ball enters the bottom of the cup at the end of the hole. The ultimate goal for each hole is to get the golf ball into the bottom of cup of the hole within or less than the number of strokes that is “par” (i.e., the required number of strokes) for that hole.

In recent years, due in large part to an increase in interest in the sport during the COVID-19 pandemic, the popularity of golf as well as related on-course (i.e., disc golf, foot golf) and off-course (i.e., long driving, mini-golf, etc.) golf-derived sports have surged not only in the United States, but around the world.

One of the most popular golf-derived sports to have emerged in the past 80 years is the sport of long driving.

While a golf club and a golf ball are used to play the sport of long driving, the similarities with traditional golf end there.

Players of the sport of long driving are not called golfers. They are called long drivers.

The sport of long driving is not played on a traditional golf course. Instead, the sport of long driving is played on a grid commonly referred to as a “long drive grid.”

A long drive grid can, in theory, be any flat physical playing surface (i.e., grass, dirt, synthetic turf, or other surfaces) or even a virtual surface.

For physical surfaces, the gridlines are typically painted on the surface on which a long drive tournament, event or competition is to be played.

A long drive grid resembles the first quadrant of a coordinate plane. A coordinate plane is a two-dimensional surface formed by two number lines, where a horizontal line (the x-axis) and a vertical line (the y-axis) intersect at a point called the origin (x=0, y=0). The numbers on a coordinate grid are used to locate points.

For a long drive grid, the outer boundaries of the long drive grid are vertical lines on the x-axis parallel to the y-axis. For example, the y-axis could be the left outer boundary of the long drive grid (x=0) and the right outer boundary of the long drive grid would be of the form x=k, where k is any real number and k is the distance of the line from the y-axis.

In order to measure the vertical distance traveled by the golf ball hit by the long driver, the grid is further subdivided into lines parallel to the x-axis. The lines parallel to the x-axis are of the form y=k, where k is any real number and k is the distance of the line from the x-axis. In theory, the distance from the x-axis can be as long as the holder of a long drive tournament, competition or event wants the grid to be, limited only by space.

The long drive grid is surrounded by an out-of-bounds area.

In the sport of long driving, a long driver is positioned within the long drive competition area at an individual teeing box, which is the position from which the long driver hits the golf balls onto the long drive grid.

The long driver then uses a golf club—usually a driver golf club (“driver club”), but any golf club may be used—to hit golf balls from the long driver's teeing box as far as possible within the vertical boundaries of the long drive grid.

Since long driving is played on a long drive grid and not a golf course, there is no concept of “par” for the course in the sport of long driving and the object of the sport of long driving is not to get a golf ball in bottom of the cup at the end of each hole on the course.

The goal of long driving is for the long driver to hit a golf ball as far as possible from the tee-box within the vertical boundaries of the long drive grid. The distance the hit golf ball travels is measured from the tee-box where the long driver hit the golf ball to the horizontal coordinate on the long drive grid.

### 2. Long Drive Handicap

a. General Description

In sports and games tournaments, handicap systems are often used. Handicapping in sports and games often refers to the methods used to offset the abilities of competitors to equalize the chance of winning or otherwise level the playing field. There are many different types of forms of handicapping systems used in sports and games, including handicapping for horse-racing, pool, bowling, sailboat racing, backgammon, and the sport of traditional on-course golf.

In traditional on-course golf, both golf handicaps and golf handicap systems are used to level the playing field among golfers in both tournaments and recreational play. The term “golf handicap” refers to a number assigned to a golfer that reflects the number of strokes the golfer will shoot to get the ball into the bottom of the cup of a hole in relation to par based on from where the golfer plays from a tee box location of a particular golf course. For example, a golfer who shoots 7-over par has a 7 handicap. A golfer who has a zero handicap is called a “scratch” golfer meaning that the golfer will usually shoot par on a golf course. The terms “golf handicap system” or “handicap index” generally refer to rating systems that rate a golfer's game and allow all golfers, irrespective of their skill level, to compete with each other on any golf course, thus leveling the playing field, providing a normalized golf score, and promoting a more competitive environment.

Over the years, multiple golf handicap systems have been developed for the sport of on-course golf, including the World Handicap System developed by the United States Golf Association (USGA) and Royal and Ancient Golf Club of St. Andrews, which calculates a handicap using a formula that approximates how many strokes above or below par a golfer will play a course, based on the golfer's most recent golf scores, the golf course rating, and the slope rating.

Common factors of the multiple golf handicap and golf handicap methods and systems in existence is that they: (1) incorporate a golf course rating, which is inapplicable to the sport of long driving since the sport of long driving is played on a long drive grid and not on a golf course; and (2) do not address or otherwise pertain to the sport of long driving, which has a completely different objective from the sport of golf. A golf course rating is inapplicable to the sport of long driving since it is not played on a traditional golf course but rather it is played on a long drive grid. In addition, since the objective of the sport of long driving is not to have a golf ball get into each hole of the course in as few strokes as possible like in traditional golf, but rather it is to have a golf ball hit by a golf club (typically a driver club) travel the furthest distance within the vertical boundaries of the long drive grid, the aforementioned handicaps are not applicable to the sport of long driving.

As a result, the handicapping methods and systems used for the sport of traditional on-course golf do not pertain or otherwise apply to the sport of long driving or the long drive grids on which the sport of long driving is played. In addition, none of the existing golf handicaps and golf handicap systems address all of the issues that the present invention does, notably because the sport of long driving, while a derivative of the sport of golf, is an entirely different sport.

The novel handicap system and method set forth in this invention, which was developed after 20 years of the applicant's confidential detailed studies and trial and error to determine the optimal system and method for calculating a long drive handicap, specifically pertains to the sport of long driving as the handicap method and system are based on ratings associated with the average clubhead speed of the long driver; the average ball speed of the golf ball hit by the long driver; and the minimum vertical distance traveled by the hit golf ball on a long drive grid.

The clubhead speed is generally referred to as the linear speed of the face of the clubhead (usually the geometric center of the striking face of the golf club) of the golf club during the downward segment of a swing. The golf ball speed is generally referred to as the post-impact (i.e., golf club strike) linear velocity of the golf ball. The ratio of the golf ball speed to the clubhead speed is also commonly known as the “smash factor” or “efficiency ratio.”

$$Efficiency Ratio = \frac{Golf Ball Speed of Hit Golf Ball}{Clubhead Speed of Golf Club Used to Hit Golf Ball}$$

This ratio measures the energy transfer efficiency from the striking face of the golf club to the golf ball. It is well-settled that the optimum efficiency ratio for a driver club is 1.5, meaning that a long driver with a 170 kph driver club clubhead swing would have a 255 kph golf ball speed. However, not every long driver hits with this optimum efficiency ratio.

In order to calculate the ball speed and clubhead speed of a long driver, any commercially available apparatus and/or method for measuring motion parameters of clubhead speed of a golf club and the velocity of a golf ball after it is hit by the long driver can be used, including launch monitors. The velocity can be measured in units of kilometers per hour (kph) or miles per hour (mph), depending on what measurement system (metric or imperial) is used.

The vertical distance traveled by each golf ball hit by the long driver is measured on the long drive grid in units of meters and centimeters or yards and inches, depending on what measurement system (metric or imperial) is used.

The systems and methods described in this disclosure provide a handicap for the sport of long driving based on ratings associated with the long driver's clubhead speed and regulated by the velocity of, and minimum distance traveled by, the golf ball that is hit by the long driver. The inclusion of these ratings and regulations into the system and method for calculating a long drive handicap is designed to not only level the playing field in the sport of long driving, but to also make the sport of long driving a neutral sport accessible to everyone irrespective of age or gender.

b. Invention's Method and System of Determining a Long Drive Handicap with a Computing Device

The present invention sets forth a novel method and system to calculate and provide a handicap for the sport of long driving.

To determine the long drive handicap of a long driver using a computing device, a long driver must first, using a golf club (ideally a driver golf club), hit a defined number of golf balls from a tee-box (shown generally at 120, 121, 122, 123) onto a long drive grid 110 within a set period of time to recreate the high-pressure and pace of a long drive tournament.

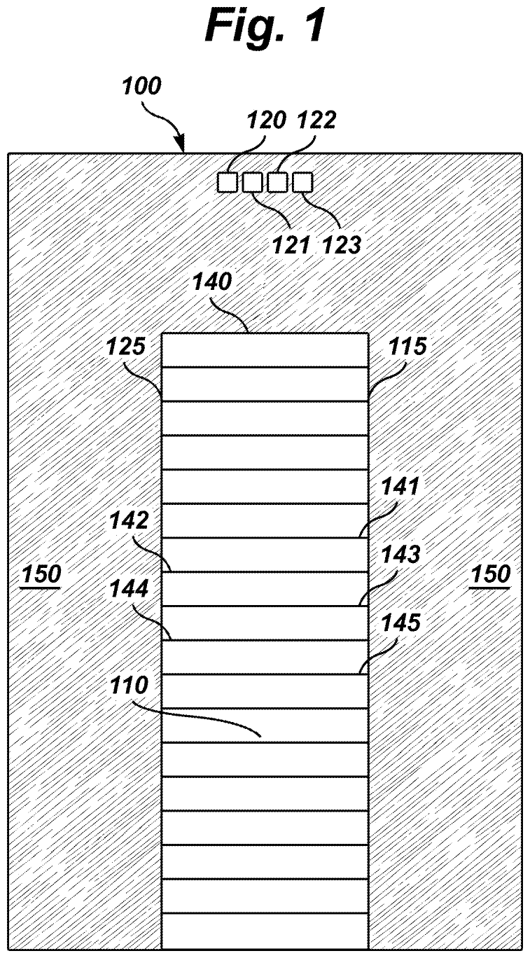

In the example of FIG. 1, a long drive competition area 100 is generally shown. Within the long competition area 100 is a long drive grid 110 with an outer left vertical boundary 115, an outer right vertical boundary 125, a lower minimum-distance horizontal boundary 140 and evenly-spaced horizontal line markers 141, 142, 143, 144, 145 that delineate the vertical measurement on the long drive grid. The long drive competition area 100 also includes four tee-boxes 120, 121, 122, 123, which are placed in an area in front of the long drive grid 110. The tee boxes 120, 121, 122, 123 are the locations from where each of the long drivers hit their respective golf balls. The long drive competition area 100 also includes an out-of-bounds area 150, which is depicted in FIG. 1 as the shaded portion of the long drive competition area 100.

The golf balls must be golf balls that that have been tested and found to conform to the Rules of Golf as established by the United States Golf Association, The R&A in St. Andrews, Scotland or another similar governing body. Each of the hits must be monitored by an apparatus and/or method for measuring motion parameters of the long driver's clubhead speed and the velocity of the golf ball hit by the long driver.

The method and system of determining a long drive handicap of a long driver using a computing device is a function of providing, to the computing device, the data associated with the long driver's average clubhead speed, the long driver's average golf ball speed and the average minimum distance traveled by the golf ball hit by the long driver into a computing device; and calculating the long driver's handicap with the computing device based on the input data.

The first step in calculating the handicap for a long driver is to determine, for each golf ball hit by the long driver within a defined period of time: (1) the long driver's clubhead speed; (2) the golf ball speed; and (3) the vertical distance traveled by the golf ball.

The second step involves the calculation of, using the computing device, of: (1) average clubhead speed of the golf balls hit by the long driver during the set period of time; and (2) the average golf ball speed of the golf balls hit by the long driver during the set period of time. If a golf ball hit by the long driver during the defined period of time does not travel a defined minimum vertical distance, the data associated with the golf clubhead speed and golf ball speed for that hit golf ball are not used in the calculation of the average clubhead speed rating and average golf ball speed rating. In that case, the average would be calculated solely using the hit golf balls that traveled a vertical distance greater than the minimum vertical distance.

The final step involves calculating the long drive handicap with a computing device by providing the data associated with the long driver's average clubhead speed rating to the computing device; and providing the data associated with the long driver's golf ball speed rating to the computing device.

In a preferred embodiment of the invention, six golf balls are given to a long driver to hit from a tee box onto a long drive grid within a set period of time in the amount of two minutes and thirty seconds. Those skilled in the art will appreciate that a different number of golf balls may be hit within a different defined period of time to calculate the long drive handicap. The amount of golf balls hit by the long driver should be an amount of golf balls large enough, and the time period in which the golf balls are hit by the long driver should be a period of time that is short enough, to recreate the time pressure of hitting golf balls during a long drive tournament. To calculate a long driver's handicap in the present embodiment, the long driver hits (each hit, a “long drive”) each of the six golf balls within the two minutes and thirty seconds from a tee-box located on a physical, or positioned in front of a virtual, long drive grid. For each long drive: (1) the clubhead speed of the golf club used is measured using a launch monitor or other similar device; (2) the golf ball speed of the golf ball hit for the long drive is measured using a launch monitor or other similar device; and (3) the golf ball must travel a minimum vertical distance as measured on the physical or virtual long drive grid. If a long driver's golf ball does not travel the set minimum vertical distance for a long drive, that long drive is deemed not valid and the clubhead speed and the golf ball speed for that long drive are not included in the calculation of the long driver's average clubhead speed and the long driver's average golf ball speed. The average clubhead speed and the average ball speed for each of the long driver's long drives that were deemed “valid” is then calculated. The data associated with the average clubhead speed rating and the data associated with the average golf ball speed rating for the long driver is then entered into a computing device or system that calculates the long drive handicap based on the input data. The long driver can repeat this process as many times as the long driver desires. As each set of golf balls are hit by a long driver within the same set period of time as the prior set of golf balls, there is new data from which to recalculate the long drive handicap using the computing system. As a result, the long driver's handicap can always rise or fall. The present invention gives the long driver an easy way to automatically recalculate and update their handicap after each the set number of long drives hit. Those skilled in the art will appreciate that the conception upon which this disclosure is based may readily be utilized as a basis for the designing of other structures, methods and systems for carrying out the several purposes of the present invention. Therefore, the claims include such equivalent constructions insofar as they do not depart from the spirit and the scope of the present invention.

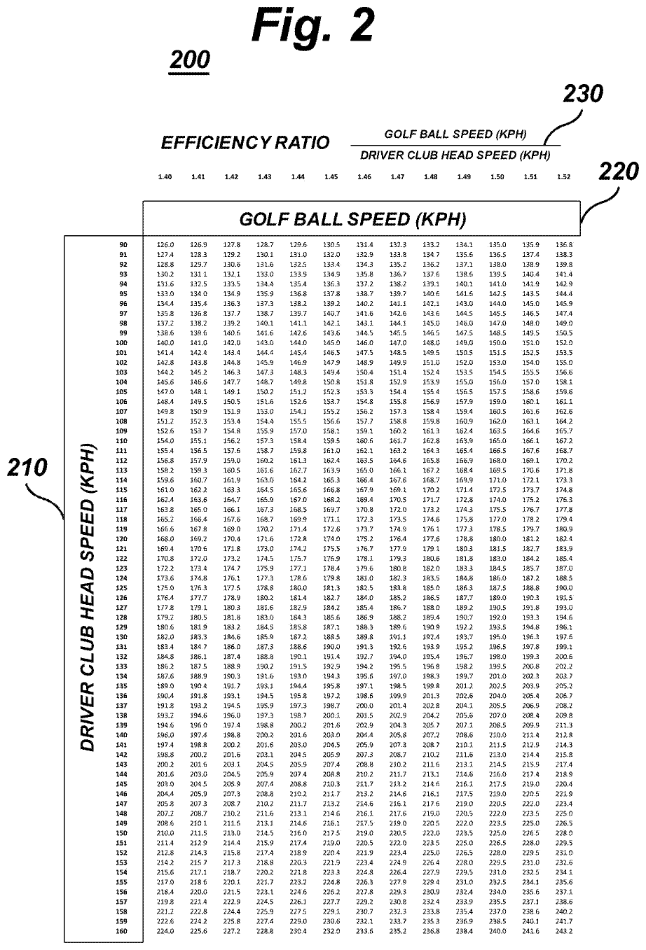

In the example in the chart 200 in FIG. 2, the clubhead speed 210 and golf ball speed 220 can vary for every long drive, resulting in a different efficiency ratio 230 for each hit.

The golf ball speed and clubhead speed ratings, however, are not the only factors that ensure that the golf ball travels a long vertical distance. A golf ball that is hit straight will travel a further vertical distance than a golf ball that is hit to the left or to the right. The closer the efficiency ratio is to 1.5 for any given clubhead speed and golf ball speed, the golf ball frequently travels a farther vertical distance.

Accordingly, the long drive handicap in the present invention incorporates ratings associated with the clubhead speed of the golf club used to hit the golf ball, the ball speed of the golf ball hit by the golf club, and a rating associated with the vertical distance traveled by the hit golf ball.

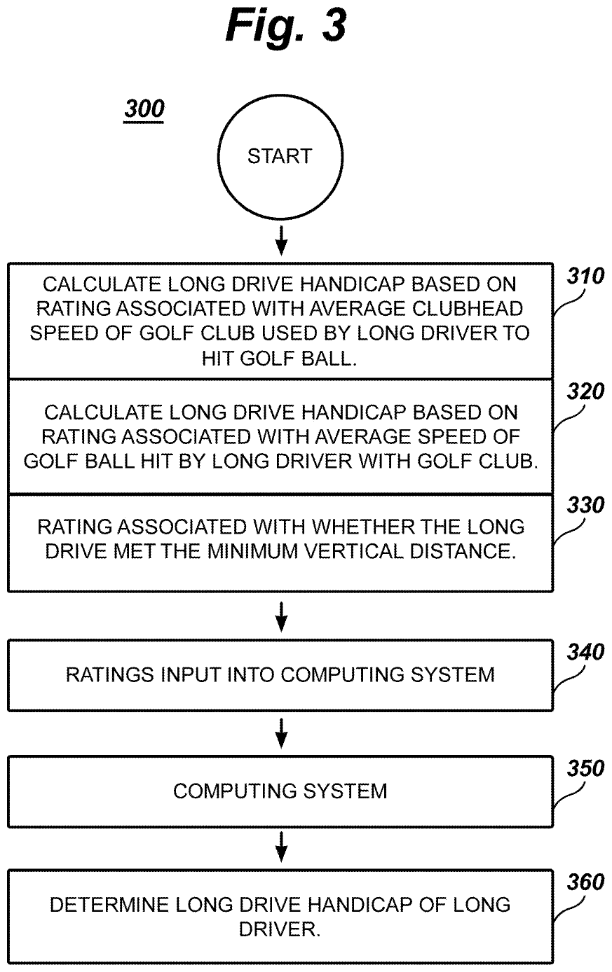

In the example of FIG. 3, a process 300 may begin with the calculation of the long driver's handicap 360 using a computing system 350 based on at least one rating associated with the average clubhead speed of a long driver 310; at least one rating associated with the average golf ball speed 320 of the golf balls hit by the long driver; and at least one rating associated with the vertical distance traveled by the golf ball hit by the long driver 330.

Each of the ratings 310 320 330 are then input 340 into a computing device 350 to determine the long drive handicap 360.

Although the process 300 is depicted as separate processes 310, 320, 330 in FIG. 3, the process 300 may be performed in other sequences to determine the long drive handicap 360. For example, two or more of the processes 310, 320, 330 depicted in FIG. 3 can be performed simultaneously or sequentially with other processes associated with the systems and methods described in this description. The systems and methods described in this description are not limited in this manner.

Using this novel handicap method and handicap system that is rated by clubhead speed 310 and regulated by both a golf ball speed rating 320 and a minimum distance traveled by the hit golf ball rating 330, long drivers will no longer have to be divided into divisions according to age or gender, but instead, it will be according to ability reflected by the long drive handicap 360.

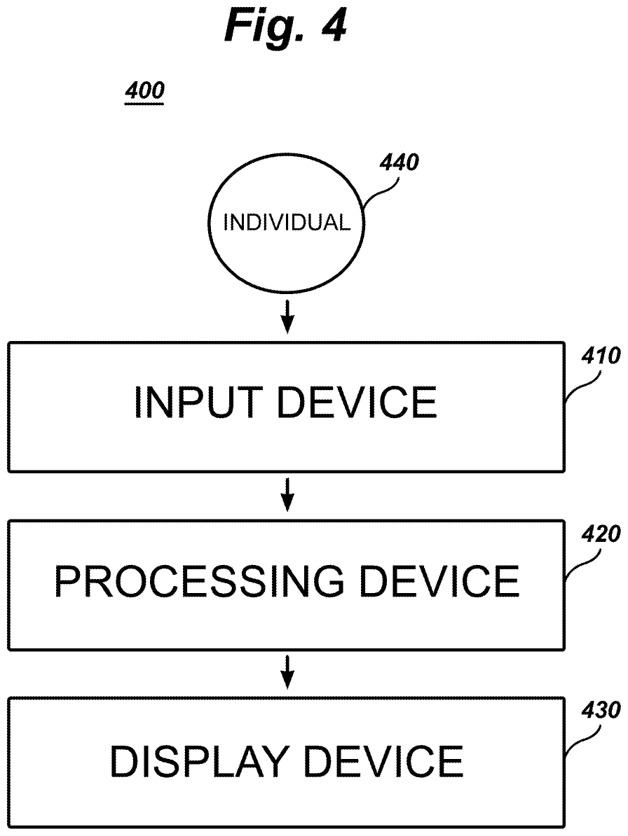

FIG. 4 is an example of how a long drive handicap method and a long drive handicap system 400 may use one or more computing devices 420, such as a computer, cell phone, table or other computing device, where the computing device 420 has both an input device 410 and a display device 430. The input device 410 may permit an individual 440 to enter data and commands into the computing device 420. The individual 440 may input a rating for the golf ball speed of the long driver through the input device 410. The computing device 420 may perform the process 300 described above to input the rating associated with clubhead speed of the long driver 310, input the rating associated with the golf ball speed of the golf ball hit by the long driver 320, and/or input the average distance traveled by the golf ball hit by the long driver 330 described above to calculate the long drive handicap. The display device 430 may display the calculated long drive handicap. Although FIG. 4 may depict one or more components being separate blocks, two or more components of the long drive handicap method and system 400 may be integrated into a single block. Those skilled in the art will also appreciate that various embodiments of the long drive handicap system 400 may include multiple computing devices 420 used by different end users.

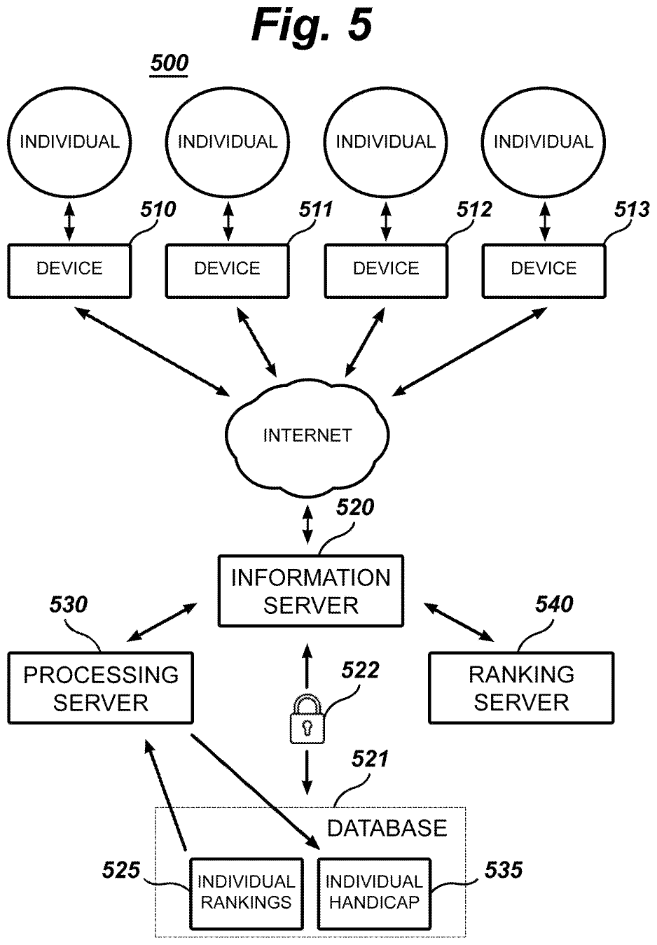

In another embodiment, shown in FIG. 5, the individual rating information and corresponding long drive handicap information of a plurality of individuals could be stored in a centralized system. FIG. 5 demonstrates how multiple computing devices 510, 511, 512, 513 used in connection with the long drive handicap method and system described in FIG. 4 could be connected to: (1) an information server 520 for a centralized database 521 configured to collect and provide the most up-to-date rating information 525 and long drive handicap information 535 of a plurality of individuals, which information server is connected to a processing server 530 that transforms the rating information for an individual into a long drive handicap 535 for that individual and relays the long drive handicap information back to the information server 520 to be updated in the database 521; and (2) a ranking server 540 connected to the information server 520. In this preferred embodiment, the database 521 could be updated with the most up-to-date rating information 525 for an individual by either the individual himself/herself/theirself on an honor-system basis, or by a third party inputting the information on behalf of an individual such as a tournament organizer; provided, however that in each case, the database could be accessible only with user authentication 522 to circumvent unauthorized access and/or the input of inaccurate information. Once the information is updated in the database 521 on the information server 520, the processing server 530 would then transform the rating information into a long drive handicap for the individual and would relay the new long drive handicap back to the database 521 on the information server 520. Using the most-up-to-date rating information and long drive handicap information for an individual in the database on the information server, the ranking server 540 would then update the ranking of an individual in the sport of long driving and relay the ranking back to the database on the information server. Tournament organizers, for example, could use the long drive handicap and ranking information to classify long drivers into the tournament speed divisions described in the present invention below.

### 3. Speed Divisions

The present invention also creates new divisions for long drive tournaments based on the novel long drive handicap method and system described above.

In sports, a division is generally referred to as a group of teams or athletes who play a sport at a similar competitive level. A division within a sports tournament typically refers to separately tracked tournaments within that sports tournament.

In the sport of long driving, the following divisions have been used by tournament organizers over the years: men's division, women's division, junior division, women's senior division and men's senior division.

The present invention creates a new divisions for long drive tournaments (each, a “Speed Division”) that do not separate tournament competitors according to age or gender, but rather separate tournament competitors according to the tournament competitor's long drive handicap described in the present invention and the outside limits of the long drive handicap maximum clubhead speed requirements, thus making the sport of long driving a neutral sport accessible to all humans, irrespective of age or gender.

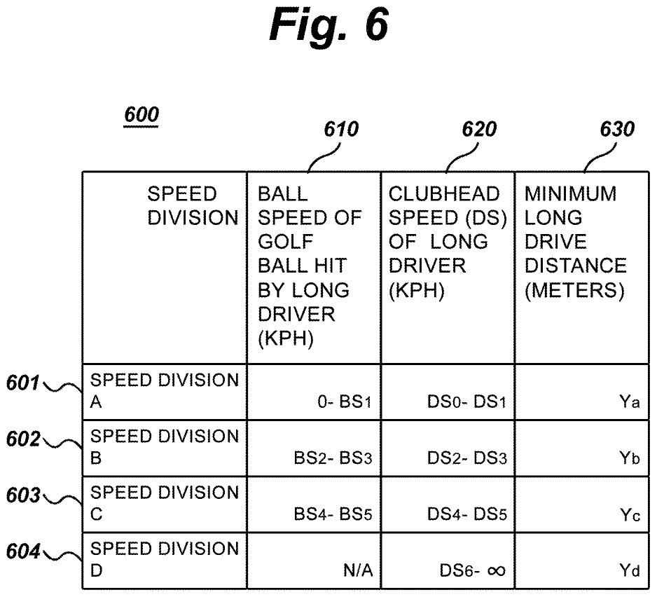

The table 600 in FIG. 6 shows how different Speed Divisions could be created for a long drive tournament, where each tournament competitor would be grouped into a Speed Division based upon his/her/their long drive handicap described in the present invention. The table 600 illustrates four possible speed divisions: Speed Division “A” 601; Speed Division “B” 602; Speed Division “C” 603; and Speed Division “D” 604. While the number of Speed Divisions in this embodiment is four, more or less Speed Divisions could be used for a long drive tournament.

Each Speed Division 601 602 603 604 in the table 600: (1) has upper and lower limits for the clubhead speed rating 620 component of the long drive handicap described in the present invention; and (2) is regulated by the ball speed rating 610 component of the long drive handicap described in the present invention and the minimum vertical distance that a hit golf ball must travel 630.

For example, if a tournament competitor's golf ball speed rating component of the long drive handicap does not exceed BS₁ and the tournament competitor's clubhead speed rating component of the long drive handicap does not exceed DS₁, that tournament competitor will be assigned to Speed Division A. If a tournament competitor's golf ball speed rating component of the long drive handicap is greater than BS₁ but does not exceed BS₃ and the tournament competitor's clubhead speed rating component of the long drive handicap is greater than DS₁ but does not exceed DS₃, that tournament competitor will be assigned to Speed Division B. If a tournament competitor's golf ball speed rating component of the long drive handicap is greater than BS₃ but does not exceed BS₅ and the tournament competitor's clubhead speed rating component of the long drive handicap is greater than DS₃ but does not exceed DS₅, that tournament competitor will be assigned to Speed Division C. If a tournament competitor's clubhead speed exceeds that DS₆, which represents a clubhead speed only achieved by the highest level of long drivers (e.g., professional long drivers), that tournament competitor will be assigned to Speed Division D. Speed Division D does is not regulated by golf ball speed; instead it is only regulated by the minimum long drive distance rating.

The creation of Speed Divisions based on the long drive handicap within a long drive tournament will allow professional long drivers to compete with novice long drivers provided that the professional long drivers lower their clubhead speed, golf ball speed and minimum vertical distance traveled to fall within the parameters of the handicap division in which the novice long driver falls.

Restated, long drivers with higher clubhead speeds who would be ordinarily grouped into a higher Speed Division may participate in a lower Speed Division, however, in order to compete in that lower Speed Division, safeguards are in place that will disqualify any tournament competitor whose ball speed exceeds the maximum limits of that Speed Division, thus preventing, what is commonly referred to as “sandbagging.”

Sandbagging is a self-presentation strategy involving the false claim or feigned demonstration of inability used to create artificially low expectations for the sandbagger's performance. See Gibson, B., & Sachau, D. (2000). Sandbagging as a self-presentational strategy: Claiming to be less than you are. Personality and Social Psychology Bulletin, 26(1), 56-70 at p. 56. The term “sandbagging” is used in many forms of sports competition. Athletes have engaged in sandbagging in sports such as: in pool where a pool shark intentionally loses games; in car racing where a driver deliberately drives at a slower speed during qualifying heats; in baseball, where pitchers sandbag batters by intentionally throwing slow pitches during warmup; in golf where a golfer sandbags by intentionally inflating his or her handicap; or in round-robin tournaments where players intentionally losing matches during the early round-robin stages of the tournament so that they could receive a more favorable position in the knock-out phase of the tournament. See Sachau, D., Simmering, L., Adler, M., & Ryan, W. (2014) Sandbagging: Faking Incompetence on the Golf Course. International Journal of Golf Science, 2014, 3, 64-77, at pp. 64-65.

“Sandbagging has proven to be a problem in any type of handicapped competition because sandbagging undermines the integrity of the handicap system.” See Sachau, D., Simmering, L., Adler, M., & Ryan, W. (2014) Sandbagging: Faking Incompetence on the Golf Course. International Journal of Golf Science, 2014, 3, 64-77, at p. 65.

The present invention has safeguards in place to disqualify any tournament competitor from sandbagging by entering into a lower Speed Division through the creation of the Speed Divisions that are regulated by ball speed. With this system and method, a tournament competitor with a long drive handicap for a higher Speed Division may play in a lower Speed Division provided that the tournament competitor does not exceed the ball speed parameters of the lower Speed Division.

As a result, with the system and method of the present invention, long drivers of high abilities can fairly compete against others with lesser abilities in a Speed Division, with those with lesser abilities having a realistic or consistent ability to win.

By way of example, using the Speed Divisions described in the preferred embodiment in the table above, if a tournament competitor that normally falls in Speed Division D wants to compete with the tournament competitors in Speed Division A, during each match, the tournament competitor may not, for any of the long drives during a match in that Speed Division A record a golf ball speed that exceeds BS₁. If the long driver from Speed Division D exceeds that limitation, the ball hit by the tournament competitor will be disqualified from the match.

### 4. System and Method of Holding Tournament

a. Speed Divisions

In the present invention, each long drive tournament will need at least one Speed Division of tournament competitors based on the long drive handicap of tournament competitors.

Within each Speed Division for the long drive tournament, there must be a defined number of tournament competitors greater than or equal to two.

b. Long Drive Pool Bracket Format

Depending on the amount of tournament competitors participating in a long drive tournament, the tournament competitors for each Speed Division are further subdivided into one or more pools of tournament competitors using a form of the pool play bracket format.

In the pool play bracket format, teams in a division are divided into one or more round-robin groups called “pools”. The teams in each “pool” play against each other team in that pool at least once during a round and compete for final standings in that pool. The top teams from each pool during a round then move onto the next round, where new pools of teams from the top teams in the other pools are created and the process is repeated. This process generally repeats for subsequent rounds until the final round of the championship.

In the present invention, a derivative format of the pool play bracket system is used. Instead of grouping teams into pools as is done with the traditional pool bracket format, the individual tournament competitors playing in a particular Speed Division in the long drive tournament are grouped into pools of tournament competitors (each, a “pool”) within the same Speed Division (the “long drive pool bracket format”). For example, depending on the number of tournament competitors playing in a Speed Division, there might be just one pool for the Speed Division or there might be two or more pools.

In a preferred embodiment, all of the tournament competitors in Speed Division A described in the table above are seeded or ranked according to their long drive handicap described in the present invention.

The tournament competitors for each other Speed Division are also seeded according to their long drive handicap within their own respective Speed Divisions for the long drive tournament (i.e., using the example set forth in the table above, all of the tournament competitors in Speed Division B are seeded according to their long drive handicaps; all of the tournament competitors in Speed Division C are seeded according to their long drive handicaps; and all of the tournament competitors in Speed Division D are seeded according to their long drive handicaps).

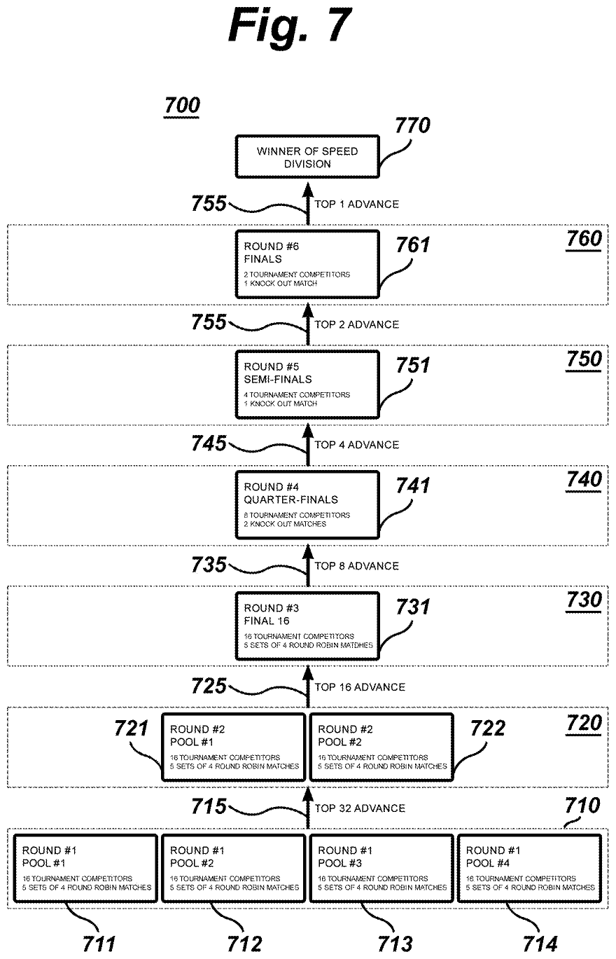

Using a flow diagram 700, FIG. 7 depicts an approach of how the long drive pool bracket format could apply to conducting the various rounds of a Speed Division within a long drive tournament according to an embodiment.

During the first round 710 of the long drive tournament, the tournament competitors in each Speed Division are subdivided into one or more smaller pools 711 712 713 714 of tournament competitors within the respective Speed Division. The pools are fairly distributed based upon the individual long drive handicap of each of the tournament competitors within the Speed Division in order to prevent a situation where the strongest tournament competitors within a Speed Division are eliminated during the first round.

During the first round of the tournament, a defined number of sets are played by each pool in the Speed Division. Each set, in turn, consists of a defined number of matches between a group of tournament competitors from the respective pool. During the first round, each tournament competitor in a pool must play against each of the other tournament competitors in that same pool at least once.

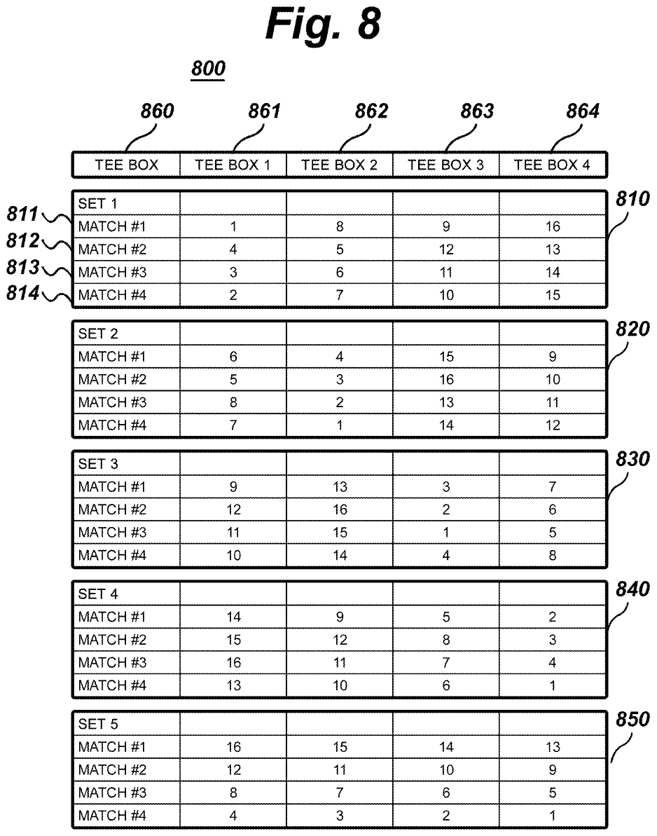

FIG. 8 is a table depicting how a round of matches 800 for a pool of tournament competitors in a Speed Division could be organized to ensure that each tournament competitor in that pool plays at least one match with each other tournament competitor in that pool during that round of the tournament competition. In this preferred embodiment of the invention, this pool consists of 16 tournament competitors from a Speed Division. Each tournament competitor in that pool of the Speed Division is assigned a number (i.e., 1, 2, 3, 4, 5, 6, etc.). There are five sets 810, 820, 830, 840, 850 in the round, with each set of the preferred embodiment consisting of four matches involving four different pairings of the tournament competitors in the pool so as to ensure that: (1) each tournament competitor in the pool plays at least one match during each set 810, 820, 830, 840, 850 of the round; and (2) each tournament competitor plays against each of the other tournament competitors at least once during the round.

FIG. 8 of the preferred embodiment shows how the round of matches 800 for a pool within a Speed Division during each set 810, 820, 830, 840, 850 in a round can be organized to ensure that each tournament competitor in a pool of the Speed Division plays a match against the other tournament competitors in the pool at least once during a round.

For example, during Set 1 810: (1) tournament competitor #1 is paired with tournament competitors #8, #9 and #16 for the first match 811 of Set 1 810; (2) tournament competitor #4 is paired with tournament competitors #5, #12, and #13 for the second match 812 of Set 1 810; (3) tournament competitor #3 is paired with tournament competitors #6, #11 and #14 for the third match 813 of Set 1 810; and (4) tournament competitor #2 is paired with tournament competitors #7, #10 and #15 for the fourth match 814 of Set 1 810. FIG. 8 also illustrates how the pairings of tournament competitors for each of the other sets 820, 830, 840, 850 can be arranged, with the end result that: (1) each tournament competitor in the pool plays at least one match during each set 810, 820, 830, 840, 850 of the round; and (2) each tournament competitor plays against each of the other tournament competitors at least once during the round. Those skilled in the art will appreciated that FIG. 8 is just one example of how tournament competitors in a pool of a Speed Division could be paired to play matches during a round so as to ensure that each tournament competitor plays against the other tournament competitors in the pool at least once during the round.

The table in FIG. 8 also indicates which tee box 860 each tournament competitor is assigned to for each match, i.e., Tee Box 1 861, Tee Box 2 862, Tee Box 3 863 and Tee Box 4 864.

c. Structure of Matches and Allocation of Points in the Long Drive Tournament

Once the matches 800 for the sets in a round (including the tee-box location for each tournament competitor in each match) for the pool of tournament competitors in a Speed Division is established by the tournament organizer, the first round for each pool of each Speed Division can begin.

As set forth above, the schematic diagram of FIG. 1 illustrates a physical long drive competition area 100, where the tee-boxes 120, 121, 122, 123 are located at a position in front of the long drive grid 110. Those skilled in the art will appreciate that a long drive competition area can be virtual and that virtual tee-boxes can be located at different locations throughout the world (both virtual and physical locations) in order for tournament competitors to play against one another in a match, with: (1) means to ensure that the results for each of the tournament competitor's drives are verified in real-time; (2) means to ensure that there are pre-determined long drive grid distance adjustments for tournament competitors competing at physical long drive grids to account for weather and long drive grid conditions to ensure that there is fairness when playing against tournament competitors using virtual long drive grids; (3) means for measuring the actual vertical distance traveled by the long drives; and (4) means for communicating the actual and adjusted (if applicable) vertical distances traveled to the tournament organizer and tournament competitors in real-time. With this flexibility, a long drive tournament can be staged with a long drive grid that is either at one or more physical; virtual; or combination of both virtual and physical locations. Using the latter example, a long drive tournament could be established where tournament competitors can participate from different locations around the world and participate in a match with other tournament competitors at the same. For example, a long drive tournament could be held using the long drive tournament method and system where one tournament competitor in a match is competing from an indoor hitting bay in Korea, another tournament competitor in the same match is located at a long drive grid in South Africa, and two tournament competitors in the same match are located at a long drive in North Carolina. In this example, the long drive tournament would be videotaped and/or livestreamed in real-time for tournament competitors and audiences alike. Not only will the speed divisions in the present invention make the sport of long driving accessible to all without regard to age or gender, but the flexibility in the manner of holding the tournaments at multiple locations will make the sport accessible to even more individuals globally.

Prior to the start time for each match, the tournament competitors in a match are called to the tee-box area. Each tournament competitor in that match is given, or otherwise required to use, a pre-set number of tournament-approved golf balls. Each golf ball given to a tournament competitor in a match must be each easily attributable (i.e., color of golf ball, writing on golf ball, pattern of the golf ball, etc.) to that tournament competitor so as to ensure that no two tournament competitors in a match use a golf ball with the same identifying characteristics. If a tournament competitor does not use a tournament-approved golf ball or uses any equipment (i.e., golf clubs, etc.) not authorized by the long drive tournament during the match, each of that tournament competitor's long drives will be automatically disqualified and will not be awarded any points.

During each match, the tournament competitors will have a defined period of time to hit the pre-set number of tournament-approved golf balls.

For each match, a shot clock is set for the defined period of time to help enforce the time limit imposed. The shot clock may be an analog or digital clock that is disposed in view of the tournament competitors, as well as the spectators.

Because of the shot-clock, each long drive tournament is fast-paced, has high drama/energy, and is action-packed.

In a preferred embodiment of the invention, each tournament competitor in a match is given six golf balls to hit within two minutes and 30 seconds. Those skilled in the art will appreciate that a different set amount of golf balls and time period in which the golf balls must be hit can be established by the tournament organizer.

d. Scoring of Matches

For each match, a number of points are awarded to each tournament competitor based on the longest “qualified long drive” (as such term is defined below) hit by such tournament competitor in the match.

The long drive tournament of the present invention provides methods for determining what constitutes a “qualified long drive”.

Drives will be measured from the tournament competitor's tee-box e.g., 120, 121, 122, 123 to the farthest horizontal grid line point e.g., 141, 142, 143, 144, 145 on which the golf ball finally rests on the long drive grid 110.

In order for a long drive to count during a match and thus be awarded points for purposes of the long drive tournament, the long drive must be a “qualified long drive.”

In the present invention, a long drive will be considered a “qualified long drive” if the golf ball hit by the tournament competitor: (1) is a golf ball provided by, or otherwise authorized by, the tournament organizer; (2) is hit using equipment authorized by the tournament organizer; (3) has a final resting place within the long drive grid 110; (4) is not be deemed out-of-bounds using any of the applicable out-of-bounds rules in place for the long drive tournament; and (5) does not record a ball speed at any point in time during flight that exceeds the maximum ball speed for the Speed Division in which the tournament competitor is participating.

An out-of-bounds rule is a preferred aspect of the present invention. If a long drive results in a golf ball being deemed “out-of-bounds,” that long drive will not constitute a “qualified long drive.” The shaded area in FIG. 1 depicts an out-of-bounds area 150 (shaded) surrounding the long drive grid 110. According to the preferred out-of-bounds rule for the present invention, the golf ball cannot come to rest outside of the left 115 and right 125 vertical boundaries and the minimum distance horizontal line marker 140 boundary (representing the minimum vertical distance that the golf ball must travel for the applicable Speed Division, the “minimum boundary line”) of the long drive grid 110. If the ball falls outside the vertical boundaries 115, 125 or at a vertical distance between the tee-boxes and the minimum boundary 140 of the long drive grid 110, the golf ball is deemed out-of-bounds and the long drive for that golf ball does not constitute a qualified long drive. Restated, a golf ball will be considered out-of-bounds if the golf ball's final resting place is: (1) not on or within the outer left vertical boundary 115 of the long drive grid 110; (2) not on or within the outer right vertical boundary 125 of the long drive grid 110; and (3) resting at a location in the long drive competition area that is between the tee-boxes and the minimum boundary line for the Speed Division in which the tournament competitor is competing. Those skilled in the art will appreciate that a long drive tournament organizer can establish additional out-of-bounds rules for the long drive tournament. For example, a preferred out-of-bounds rule for the present invention provides that if a golf ball hits an immovable object or other obstruction outside of the grid 150 and bounces back into the long drive grid 110 after hitting such obstruction or immovable object, that golf ball will be considered “out-of-bounds.” Another preferred out-of-bounds rule for the present invention provides that if a golf ball is not found within a set period of time after the match has ended (such amount of time not to exceed the time period of the actual match), the golf ball is also considered “out-of-bounds.”

In addition to the requirement that the golf ball have a final resting place on the long drive grid 110 and not be out-of-bounds in order to be considered a qualified long drive, a long drive must not record a ball speed that exceeds the maximum ball speed for the Speed Division in which the tournament competitor is participating. Restated, the ball speed of the golf ball hit by a tournament competitor during a match cannot exceed the maximum ball speed for the tournament competitor's Speed Division as generally set forth in FIG. 6. If the ball speed of a hit golf ball during a match exceeds the outer golf ball speed limit for that Speed Division at any time during flight, that long drive will not constitute a qualified long drive for purposes of the match.

The present invention also contemplates a disqualification rule designed to prevent sandbagging in long drive tournaments. A disqualification rule designed to prevent sandbagging could provide that if the golf ball speed of any golf ball hit during a match by a tournament competitor is greater than or equal to “z” units per hour (with “z” being a set unit/hour measured in mph or kph, depending on whether the long drive tournament organizer is using the imperial or metric system to measure golf ball speed) more than the maximum golf speed limit for that Speed Division, then all of the long drives of that tournament competitor during that match are disqualified. For example, assume that: (1) in a match, a tournament competitor must is given six golf balls to hit within a two minute and 30-second period of time during a match; (2) the tournament organizer of a long drive tournament introduced a rule to prevent sandbagging in the long drive tournament that provides that if any one golf ball hit by a tournament competitor during a match exceeds the maximum golf ball speed limit of the Speed Division by 10 mph (i.e., z=10 mph), all of the tournament competitor's long drives during a match will be disqualified; and (3) a tournament competitor is participating in a Speed Division where the upper golf ball speed limit of that division is 150 mph. If the tournament competitor in a match in this example hits six long drives onto the long drive grid, but two of the golf balls had golf speeds of 151 mph, only four of the long drive will count as “qualified long drives,” with points being assigned to that tournament competitor's longest qualified long drive. However, if the long driver hit six long drives onto the long drive grid during a match, but one of the golf balls had a golf speed of 161 mph, all of the tournament competitor's long drives would be disqualified for that match of the long drive tournament since the golf ball speed of one of the long drives exceeded the maximum golf ball speed limit for that Speed Division by more than 10 mph.

For each match, the tournament competitors in the match are awarded points based on their rankings during that match. Each tournament competitor's longest qualified long drive for a match will establish their standing within a group of the four tournament competitors in that particular match. In a preferred embodiment, the tournament competitor with the longest qualified long drive will receive the most amount of points; the tournament competitor with the second longest drive will receive half of the points awarded to the tournament competitor in first place; the tournament competitor with the third longest drive will receive half of the points awarded to the tournament competitor in second place; and the tournament competitor with the short qualified long drive will receive half of the points awarded to the tournament competitor in third place. No points are awarded to a tournament competitor in a match if: (1) that tournament competitor does not have at least one qualified long drive during the match; or (2) if that tournament competitor is disqualified during that match.

The following table sets forth an exemplary scoring system. For example, if 200 points are awarded to a tournament competitor with the longest qualified long drive in a match (and assuming that there are no ties in the match and each tournament competitor participating in the match hit at least one qualified long drive), then the points for the match will be allocated as follows:

| RANK | POINTS AWARDED | |
|---|---|---|
| FIRST PLACE | 200 | points |
| SECOND PLACE | 100 | points |
| THIRD PLACE | 50 | points |
| FOURTH PLACE | 25 | points |
| No qualified long drives for all balls | 0 | points |
| hit/disqualified | | |

The present invention also contemplates rules for situations in which there are ties. The present invention defines a tie as a situation in which there are two or more qualified long drives that are confirmed as identical in length or that are within 15 cm (or such other length determined by the tournament organizer) of the other qualified long drive. Tie-breaker rules can vary by event depending on the decision of the long drive tournament organizer. In a preferred embodiment of the present invention, in the event of a tie, the positions that are tied will be added together and divided equally amongst the tournament competitors tied for the position during a match. For example, if there is a three-way tie for first place in a match, the points for first place, second place and third place will be added together and then divided equally amongst the three first place winners. Using the example points allocation chart set forth above, in this case, the 200 points is awarded for first place, 100 points is awarded for second place, 50 points is awarded for third place for a total of 350 points. The 350 points would be divided into three equal shares. Accordingly, in this example of a tie, 116^{2/3} points will be awarded to each of the three tournament competitors tied for first place.

If a tournament competitor does not hit any qualified long drives in a match, then no points will be awarded for that match and the score for that tournament competitor will be 0.

As set forth above, the tournament competitors in a Speed Division are divided into smaller pools of tournament competitors for the first round of the long drive tournament for that Speed Division. In the example set forth in FIG. 8, the first round of the long drive tournament for each pool in a Speed Division is divided into five (5) sets 810, 820, 830, 840, 850, with each set consisting of four matches (e.g., 811, 812, 813, 814).

During each match, points are awarded to the tournament competitors for his/her/their longest qualified long drive; similarly, no points are awarded if all of the golf balls hit by a tournament competitor during a match are out-of-bounds or the tournament competitor is disqualified for pursuant to one of the disqualification rules of the long drive tournament.

d. Additional Rounds of the Long Drive Tournament Using Speed Divisions

Once all of the sets of the first round for each pool in the Speed Division have taken place, the points awarded to each tournament competitor during each match in each pool of a Speed Division are aggregated. In the preferred embodiment illustrated in FIG. 7, the scores of the tournament competitors from each of the pools during the first round 710 are combined and the top half of tournament competitors with the most points from all of the pools in the division then advance 715 to the next round 720; the bottom half of the tournament competitors from all of the pools of that Speed Division during the first round are cut.

Using the rankings of the tournament competitors from the first round 710 of the Speed Division using the preferred embodiment, new pools of tournament competitors from the Speed Division are formed using the present invention's long drive pool bracket format. The flow diagram 700 in FIG. 7 illustrates how the remaining tournament competitors in the Speed Division after the first round are subdivided into one or more smaller pools 721 722 of tournament competitors for the second round 720 of a Speed Division. The pools are fairly distributed based upon the current rankings of the tournament competitors after the first round 710 of the Speed Division in order to prevent a situation where the strongest tournament competitors within a Speed Division are eliminated during the second round.

Once all of the sets of the second round 720 for each pool 721 722 in the Speed Division have taken place in the preferred embodiment, the points awarded to each tournament competitor during each match in each pool of the Speed Division during the second round 720 are aggregated. The results from each of the pools during the second round are combined and the top half of tournament competitors with the most points from all of the pools in the division during the second round 720 then advance 725 to the third round 730; the bottom half of the tournament competitors from all of the pools of that Speed Division during the second round are cut.

Using the rankings of the tournament competitors from the second round 720 of the Speed Division in the preferred embodiment, a new pool 731 of tournament competitors from the Speed Division are formed using the present invention's long drive pool bracket format for the third round 730 of a Speed Division.

The tournament organizer then schedules the matches 800 for the remaining pool 731 in the third round 730 of the Speed Division in the preferred embodiment. Once all of the sets of the third round 730 for the pool 731 in the Speed Division have taken place, the points awarded to each tournament competitor during each match in each pool of the Speed Division during the third round are aggregated. The top half of tournament competitors with the most points in the remaining pool of the third round 730 then advances 735 to the fourth round 740, which is referred to as the “quarter-finals” in the preferred embodiment; the bottom half of the tournament competitors from the remaining pool of that Speed Division during the third round is cut.

During the fourth round 740 of the preferred embodiment, with just eight tournament competitors remaining 741, two sets of knock-out matches are conducted with the remaining tournament competitors. The tournament organizer schedules the two remaining knock-out matches based on the rankings of the tournament competitors during the third round in a fair manner, so as to ensure that the top two remaining tournament competitors do not play a knock-out match against each other during the fourth round/quarter-finals. For example, the tournament competitor ranked #1 during the third round would be paired with the tournament competitors ranked #3, #5 and #7 during the third round and the tournament competitor ranked #2 would be paired with the tournament competitors ranked #4, #6 and #8 during the third round. The top two competitors from each match during the fourth round then advance 745 to the fifth round or the semi-finals of the Speed Division in the preferred embodiment.

During the fifth round of the Speed Division of the preferred embodiment, there are just four tournament competitors remaining in the Speed Division. One knock-off match is held. The top two tournament competitors advance 755 to the sixth round or finals 760 of the Speed Division.

During the finals of the preferred embodiment, the top two remaining tournament competitors play one match against each other. The tournament competitor with the longest qualified drive during the match advances 755 as the winner of the Speed Division 770.

As described above, in the preferred embodiment shown in FIG. 7, the total number of tournament competitors in a Speed Division for a long drive tournament is 64 tournament competitors. For the first round of the Speed Division 710, the tournament competitors in the Speed Division are grouped into four pools 711, 712, 713, 714, each comprising of 16 tournament competitors. During the first round 710 of the long drive tournament for that Speed Division, each pool 711, 712, 713, 714 plays five sets of matches as set forth in the preferred embodiment shown in FIG. 8. Each set 810, 820, 830, 840, 850 comprises of four matches (e.g., 811, 812, 813, 814) between four tournament competitors in the respective pools. After the first set of the round for each pool is completed, each tournament competitor in that pool should have played against each of the other tournament competitors in that pool at least once. During each match of the round, tournament competitors within the pool are paired with each other to hit the golf balls at the same time from their respective tee-boxes 110, 120, 130, 140 on the long drive grid 100 for a set time period of time defined by the tournament organizer. At the end of the set time period, the longest qualified long drive for each tournament competitor is determined and each tournament competitor is awarded points for their longest qualified long drive of the match. At the end of the five sets, the total amount of points awarded to the tournament competitors during the matches for all four of the pools are added. The top half of the tournament competitors in all of the pools in the Speed Division (i.e., 32 in this preferred embodiment) are determined and those tournament competitors advance to the next round in the competition 715; the bottom half of the tournament competitors in the Speed Division are cut. During the next round 720 of the long drive tournament, the 32 remaining tournament competitors (i.e., the top half of the tournament competitors from the first round) are grouped into two new “pools” of tournament competitors 721, 722, with each pool comprising of 16 tournament competitors. Each new pool completes five sets of four matches in the same manner as in the first round. At the end of the fifth set, the total amount of point awarded to each tournament competitor during the round are added up and the top half of the tournament competitors (i.e., 16 tournament competitors) advance to the next round 725. During the next round 730, the remaining 16 tournament competitors (i.e., the top half of the tournament competitors from the second round) are grouped into one pool of tournament competitors comprising of all 16 tournament competitors 731. That pool completes five sets of four matches in the same manner as in the prior rounds. At the end of the fifth set, the total amount of point awarded to each tournament competitor during the round are added up and the top half of the tournament competitors (i.e., 8 tournament competitors) advance to the next round 735. During the next round, the remaining 8 tournament competitors (i.e., the top half of the tournament competitors from the third round) are grouped into two groups of four tournament competitors 741. Each group must play one knockout match. The top two tournament competitors from each group with the most points after each match advance 745 to the semi-finals. In the next round 750, the remaining four tournament competitors play one match against each other 751. The top two tournament competitors with the most points during that knockout match advance 755 to the finals. During the final round 760, the top two tournament competitors play one match 761. The tournament competitor with the longest qualified long drive during that match wins 765 that Speed Division of the long drive tournament and is declared the winner of the Speed Division 770.

While the preferred embodiment assumed that a total of 64 tournament competitors participated in a Speed Division, those skilled in the art will appreciate that more or less tournament competitors can participate in a Speed Division in a long drive tournament using the long drive pool bracket system of the present invention. The long drive pool bracket system, where: (1) each of the tournament competitors in a pool plays a defined number of sets during a round ensuring that each tournament competitor in that pool plays at least one match against each of the other tournament competitors in that pool; and (2) the top half of the tournament competitors according to scores awarded during a round advance to the next round, is used until there are less than nine tournament competitors left in the Speed Division. At that point, the tournament competitors are divided into two groups of tournament competitors. Each group of tournament competitors plays one knock-out match. The top two tournament competitors in each group moves on to the semi-finals and one knock-out match is played. The top two tournament competitors then move on to the finals. During the finals, the tournament competitor with the longest qualified long drive wins the Speed Division.

Although certain example methods and systems have been described in the present application for the invention, the scope of coverage of this disclosure is not limited to the foregoing and those skilled in the art will appreciate that this invention is capable of further modifications and may readily be utilized as a basis for the designing of other methods and systems for carrying out the several purposes of the present invention. Therefore, the claims and the rest of this application is intended to cover and include such equivalent constructions insofar as they do not depart from the spirit and the scope of the present invention.

What is claimed is:

1. A system for conducting a long drive tournament, played by a set number of tournament competitors each playing an initial number of predetermined matches at either the same physical long drive grid, different remote and/or virtual locations and/or a combination of physical long drive grid, remote and/or virtual locations, the system comprising:
means for grouping, using a computing device, tournament competitors participating in a long drive competition into speed divisions for the long drive tournament pursuant to each tournament competitor's long drive handicap;
means for governing the speed divisions by upper and lower clubhead speed limits and regulating the speed divisions by golf ball speed;
means for establishing at least one speed division for elite tournament competitors that tournament competitor may join if he/she/they possess a long drive handicap and/or have a clubhead speed rating that exceeds a pre-determined minimum clubhead speed for that speed division, which speed division is not regulated by golf ball speed;
means for allowing tournament competitors of different abilities to participate in a different speed division from the one that the tournament competitor was sorted into based on the long drive handicap so long as the tournament competitor does not hit any golf balls that exceed the upper limit of the clubhead speed and upper limit of the golf ball speed for that speed division;
means for, within each speed division, using a computing device, ranking or seeding competitors pursuant to each tournament competitor's long drive handicap for the initial round and for subsequent rounds, their actual rankings in the long drive tournament;
means for establishing one or more physical and/or virtual long drive grids for the long drive competition in one or more geographic locations;
means for determining whether and how adjustments will be made to the actual vertical distance traveled by the golf ball to normalize playing conditions between tournament competitors playing in a match from one or more physical and/or virtual long drive grids;
means for, using a recording device, videotaping and/or livestreaming each match in real-time featuring each of the tournament competitors participating in the match from each of the locations in which the tournament competitors are participating;
means for using a shot clock or similar device for each match to ensure that each tournament competitor hits the set number of golf balls for the match within the same period of time, irrespective of whether the tournament competitor is competing in a match from a different geographic location;
means for determining if there will be any required adjustments for vertical distance traveled measurements taking into account the weather and playing conditions at the physical long drive grids at the time of the long drive competition;
means for, using a launch monitor or similar device, to record the golf ball speed of each golf ball hit during a match for each tournament competitor to ensure that the hits golf balls do not exceed the maximum golf ball speed limit for the speed division in which the tournament competitor is participating;
means for allowing the tournament competitors to participate in a long drive tournament from different geographic using physical and/or virtual long drive grids;
means for measuring the physical or virtual vertical distance traveled by a golf ball for each tournament competitor participating in a match;
means for displaying to the tournament organizer, tournament competitors and physical and virtual audiences the actual and adjusted physical and/or virtual distance results as well as the golf ball speed information for each tournament competitor participating in a match, which results are communicated to, and verified by, the tournament organizer so tournament competitors can play with each other simultaneously from one or more locations;
means for determining the qualified long drives of each tournament competitor during a match;
means for transforming the adjusted physical and/or vertical distance results of each qualified long drive during a match into points, and communicating the results through display systems in real time allowing tournament competitors to participate in matches with each other from one or more different geographic locations and audiences to watch the long drive tournaments from anywhere in the world; and
means for, using a computing device, organizing different rounds of matches among tournament competitors for each speed division until there is a winner of each speed division for the long drive tournament.

2. The system in claim 1 where the long drive handicap represents a value assigned to the tournament competitor after the tournament competitor hits a pre-set number of golf balls with a golf club within a defined period of time onto a physical or virtual surface; measures, using a commercially available device for measuring clubhead speed and golf ball speed, the clubhead speed of the golf club used by the individual for each of the golf balls hit and the golf ball speed of each golf ball hit; determines whether the golf ball hit is a qualified long drive that traveled a minimum vertical distance; and calculates, using a computing device, the average golf ball speed rating and average clubhead speed rating for the qualified golf balls; and using a computing device, transforms the measured properties into a value, which represents the individual's long drive handicap.

3. The system in claim 1 where tournament competitors are ranked, using a computing device, according to their respective long drive handicaps and sorted into speed divisions for the long drive tournament according to their long drive handicaps into speed divisions that are governed by clubhead speed and regulated by golf ball speed for the long drive tournament.

4. The system in claim 1 where a tournament competitor may participate in a different speed division than the one in which the tournament competitor would normally be assigned to as a result of the tournament competitor's long drive handicap provided that the tournament competitor's measured clubhead speed and measured golf ball speed for the golf balls hit by that tournament competitor do not exceed the minimum and maximum speeds established for that speed division in which the tournament competitor is participating.
